(19) United States
(12) Patent Application Publication
(10) Pub. No.: US 2006/0036922 A1
(43) Pub. Date: Feb. 16, 2006

(54) Apparatus and method for changing signal mapping rule in a hybrid automatic repeat request system

(75) Inventors: Sung-Kwon Hong, Seoul (KR); Jung-Min Ro, Seoul (KR); Young-Kwon Cho, Suwon-si (KR); Young-Kyun Kim, Sungnam-si (KR); Dong-Seek Park, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/204,941

(22) Filed: Aug. 16, 2005

(30) Foreign Application Priority Data
Aug. 16, 2004 (KR) 2004-0064442

(51) Int. Cl. H04L 1/18; G08C 25/02

(52) U.S. Cl. 714/748

(57) ABSTRACT

An apparatus and method for changing a signal mapping rule in an hybrid automatic repeat request (HARQ) system are provided. In a transmitter in an automatic repeat request (ARQ) system according to the present invention, a memory stores different signal constellations for a predetermined modulation scheme according to retransmission numbers (k). A modulator reads a signal constellation according to a current retransmission number from the memory, upon receipt of a retransmission request signal from a receiver, and modulates transmission data to complex symbols on the signal constellation.

### PRIORITY

This application claims priority under 35 U.S.C. § 119 to an application entitled “Apparatus And Method For Changing Signal Mapping Rule In A Hybrid Automatic Repeat Request System” filed in the Korean Intellectual Property Office on Aug. 16, 2004 and assigned Serial No. 2004-64442, the contents of which are incorporated herein by reference.

### BACKGROUND OF THE INVENTION

1. Field of the Invention

The present invention relates generally to a multiple-input multiple-output (MIMO) hybrid automatic repeat request (HARQ) system and, in particular, to an apparatus and method for changing a signal mapping rule for a retransmission in an HARQ system using a space-time block code (STBC).

2. Description of the Related Art

HARQ is a combination of automatic repeat request (ARQ) and error correction coding.

ARQ is an error control mechanism in which a receiver checks transmission errors in a frame received on a communication channel and upon detection of errors, automatically requests a retransmission from the transmitter, and the transmitter retransmits the frame. Therefore, robustness against errors on the communication channel is increased. The error check is performed by means of an error detection code that the transmitter has attached to an information bit stream.

In comparison, an error correction code is created by adding additional information to an original information frame and the receiver corrects channel errors using only the received frame.

The ARQ scheme can be combined with an error correction code in many ways, including the following:

(1) When the receiver detects errors in an error-correction coded frame, the transmitter retransmits the same frame as the original frame and the receiver decodes the retransmission frame independently.

(2) When the receiver detects errors in an error-correction coded frame, the transmitter retransmits the same frame as the original frame and the receiver decodes the retransmission frame using the previous received frame. At decoding, the previous frame and the current frame (i.e. the retransmission frame) are soft-combined by “chase combining”. From the transmitter's point of view, the two frames are perfectly the same, but they arrive with different values at the receiver due to distortion and noise on the channel. The receiver decodes by calculating the arithmetic average of the previous frame and the current frame. This type of decoding is called chase combining.

(3) When the receiver detects errors in an error-correction coded frame, the transmitter transmits a different frame from the transmitted frame at a retransmission. The retransmission frame is different in that the same information is encoded with a different coding method and this frame is transmitted at the retransmission. The retransmission frame is so designed that code combining of the previous frame with the retransmission frame outperforms chase combining.

A brief overview of chase combining is presented below, with reference to the diagram of FIG. 1A, which illustrates a signal flow for the operation of an ARQ system using chase combining in the absence of errors in a received frame. Referring to FIG. 1A, the transmitter encodes a P^{th} frame and transmits the P^{th} frame in step 101. In step 103, the receiver decodes the received P^{th} frame and checks errors in the P^{th} frame. As described before, the error check is performed using an error detection code. In the absence of errors in the P^{th} frame, the receiver transmits an acknowledgement (ACK) signal to the transmitter in step 105. The transmitter then encodes a (P+1)^{th} frame and transmits the (P+1)^{th} frame in step 107. In step 109, the receiver decodes the received (P+1)^{th} frame and checks errors in the (P+1)^{th} frame. In the absence of errors in the (P+1)^{th} frame, the receiver transmits an ACK signal to the transmitter in step 111.

FIG. 1B is a diagram illustrating a signal flow for the operation of the ARQ system using chase combining in the presence of errors in a received frame. Referring to FIG. 1A, the transmitter encodes a P^{th} frame and transmits it in step 121. In step 123, the receiver decodes the received P^{th} frame and checks errors in the P^{th} frame. Also, the receiver stores the received P^{th} frame as frame P_1 in a memory. Upon detection of errors in the P^{th} frame, the receiver transmits a non-acknowledgement (NACK) signal to the transmitter in step 125. The transmitter then encodes the P^{th} frame using the same code as for the previous transmitted pth frame and retransmits it in step 127, instead of transmitting a (P+1)^{th} frame. In step 129, the receiver combines the retransmission frame (i.e. frame P_2) with frame P_1, for decoding and checks errors in the combined frame. In the absence of errors, the receiver transmits an ACK signal to the transmitter in step 131. Otherwise, in the presence of errors, the receiver transmits an NACK signal again to the transmitter and the transmitter retransmits the Ph frame. As described above, a retransmission frame is identical to an initial transmission frame in chase combining.

The third retransmission method, can be considered in two ways. In one way, the receiver decodes the retransmission frame independently, without the aid of the previous transmitted frame. Although code combining provides a coding gain, decoding using only the retransmission frame makes it possible to cope with various communication channel conditions. Another way is that the receiver cannot decode the retransmission frame independently. Since a retransmission frame typically delivers too small an amount of additional information for decoding the whole information frame, independent decoding is impossible at the receiver although the retransmission frame may be transmitted in a smaller unit, compared to other retransmission schemes. This scheme is called incremental redundancy (IR). In general, IR performs excellently in terms of transmission throughput.

Active studies have recently been conducted on communications using multiple antennas at both the transmitter and the receiver. The multiple transmit/receive antenna scheme is called MIMO. The MIMO environment is expected to yield higher channel capacity than a single-input single-output (SISO) environment. Thus, the MIMO is under study as a promising scheme for future-generation communication systems.

The MIMO is a kind of space-time code (STC) scheme. According to the STC scheme, a signal encoded in a predetermined coding method is transmitted through a plurality of transmit antennas so that coding in the time domain is extended to the frequency domain. As a result, a lower error rate is achieved.

Since the introduction of the concept of space-time trellis code (STTC) by Tarokh, continual efforts have been made to improve STC performance. Tarokh found out that STTC performance is determined by the minimum determinant of a signal matrix. Baro et al. detected an optimum code that maximizes the minimum determinant by searching all possible generator coefficients for the Tarokh's STTC structure. Thereafter, Yan et al. presented a novel code based on a performance criterion that maximizes a determinant in a general term as well as takes the minimum determinant into account. It is known that Yan's STTC performs best for a single receive antenna.

For two or more receive antennas, due to multipath fading of a channel, as the number of receive antennas increases, channel distortion is modeled as additive white Gaussian noise (AWGN) according to the central limit theorem. Based on this fact, Chen et al. stated that the minimum squared Euclidean distance dominates performance under AWGN, rather than the minimum determinant. Chen's STTC is known to provide the best performance for two or receive antennas.

In an STC system with n transmit antennas and m receive antennas, error probability and STC performance are determined according to the following criteria in a slow static fading channel environment. If an STC-coded sequence transmitted on a channel (or an STC matrix) is denoted by c and a distortion-caused erroneously decodable sequence (i.e. an error sequence for c) is denoted by e, then, c and e are expressed as Equation 1:

$$\begin{matrix}c = ( \begin{matrix}{c}_{1}^{1} , {c}_{2}^{1} , ⋯ , {c}_{l}^{1} \\ {c}_{1}^{2} , {c}_{2}^{2} , ⋯ , {c}_{l}^{2} \\ ⋯ \\ {c}_{1}^{n} , {c}_{2}^{n} , ⋯ , {c}_{l}^{n}\end{matrix} ) , & e = ( \begin{matrix}{e}_{1}^{1} , {e}_{2}^{1} , ⋯ , {e}_{l}^{1} \\ {e}_{1}^{2} , {e}_{2}^{2} , ⋯ , {e}_{l}^{2} \\ ⋯ \\ {e}_{1}^{n} , {e}_{2}^{n} , ⋯ , {e}_{l}^{n}\end{matrix} )\end{matrix} \qquad ( 1 )$$

where the number of the rows in the matrices is equal to that of transmit antennas, and the number of the columns is equal to the length of the STC code.

If A=(c−e)(c−e)* (* denotes transpose conjugate) is a signal matrix having rank r and the determinant is represented as Det, the STC error probability is computed by Equation 2:

$$P ( c \to e ) = {( Det )}^{- m} {( \frac{{E}_{s}}{4 {N}_{o}} )}^{- rm} \qquad ( 2 )$$

where r denotes the rank of the matrix A, m denotes the number of Rx antennas, Eₛ denotes symbol energy and N₀ denotes noise.

As noted from Equation 2, to minimize the error probability, two criteria should be satisfied: the signal matrix should be full rank; and the minimum determinant of the signal matrix should be maximized. The above error performance is determined according to design criteria which vary depending on the number of receive antennas. As the number of receive antennas increases, channel distortion is approximate to the effect of AWGN noise according to the central limit theorem. That is, the channel becomes similar to an AWGN channel, and not the minimum determinant but the minimum squared Euclidean distance serves as a performance criterion for the AWGN channel. The minimum squared Euclidean distance is equivalently the trace of the signal matrix (i.e. the sum of the diagonal elements). In this case, the rank criterion is less strict so that a full rank is not a requisite and a rank of 2 or higher suffices.

As described above, since it was known that the minimum squared Euclidean distance is a dominant performance factor for a plurality of antennas, STTC has been an active study area to exploit an STC for increasing the minimum squared Euclidean distance. On the other hand, STBC has been studied in the direction of maximizing the minimum determinant under the assumption of a fixed minimum squared Euclidean distance. However, STBC performance is yet to be studied in terms of increasing the minimum squared Euclidean distance.

Assuming that the channel environment at a retransmission is independent of that at an initial transmission in a MIMO-HARQ system, a retransmission frame can be modeled as a frame received at an independent receive antenna. If the receiver has a plurality of receive antennas, a significant factor that determines the performance of coding and modulation is the minimum squared Euclidean distance. Increasing the minimum squared Euclidean distance at a high signal-to-noise ratio (SNR) provides better performance than improving error events. As described above, changing a signal mapping rule at every retransmission with the objective of increasing the minimum squared Euclidean distance is expected to outperform conventional chase combining in a MIMO-HARQ system using an STBC.

### SUMMARY OF THE INVENTION

An object of the present invention is to substantially solve at least the above problems and/or disadvantages and to provide at least the advantages described below. Accordingly, an object of the present invention is to provide an apparatus and method for changing a signal mapping rule at every retransmission to increase the minimum squared Euclidean distance in an HARQ system. Another object of the present invention is to provide an apparatus and method for changing a signal mapping rule at every retransmission to increase the minimum squared Euclidean distance in a MIMO-HARQ system using an STBC. The above objects are achieved by providing an apparatus and method for changing a signal mapping rule in an HARQ system.

According to one aspect of the present invention, in a transmitter in an ARQ system, a memory stores different signal constellations for a predetermined modulation scheme according to retransmission numbers (k). A modulator reads a signal constellation according to a current retransmission number from the memory upon receipt of a retransmission request signal from a receiver, and modulates transmission data to complex symbols on the signal constellation.

According to another aspect of the present invention, in a receiver in an ARQ system having a table for storing different signal constellations for a predetermined modulation scheme according to a retransmission number (k), a decoder acquires a metric for a current transmission by decoding received complex symbols using reference signal points from a signal constellation corresponding to a current retransmission number, combining the current metric with metrics for previous transmissions, and decides received data based on the combined metric. An error detector checks errors in the received data from the decoder, and an ARQ controller transmits a feedback signal to a transmitter according to an error check result received from an error detector.

According to a further aspect of the present invention, in a transmission method in a transmitter in an ARQ system having a table for storing different signal constellations for a predetermined modulation scheme according to a retransmission number (k), a signal constellation is read from the table according to a current retransmission number, upon receipt of a retransmission request signal from a receiver. Transmission data is modulated to complex symbols on the signal constellation.

According to still another aspect of the present invention, in a reception method in a receiver in an ARQ system having a table for storing different signal constellations for a predetermined modulation scheme according to a retransmission number (k), reference signal points are acquired from a signal constellation corresponding to a current retransmission number. A metric for a current transmission is calculated by decoding received complex symbols using the reference signal points. The current metric is combined with metrics for previous transmissions. Received data is decoded based on'the combined metric and errors are checked in the received data. A feedback signal is transmitted to a transmitter according to an error check result.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B illustrate signal flows for operations of an ARQ system using chase combining;

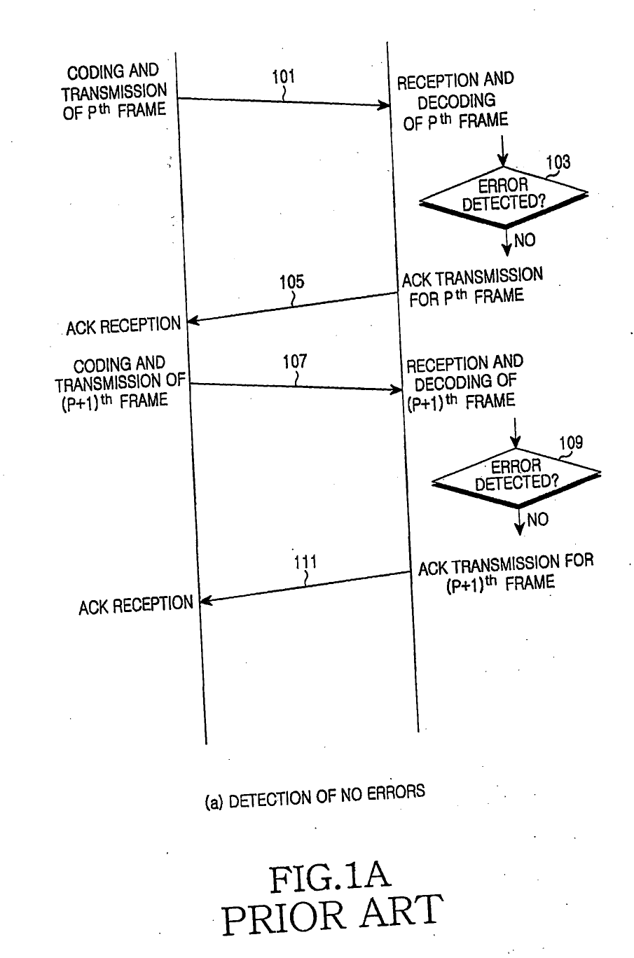

FIG. 2 is a block diagram of a MIMO-HARQ system according to an embodiment of the present invention;

FIG. 3 is a flowchart illustrating a transmission operation in a transmitter in an STBC-using HARQ system according to an embodiment of the present invention;

FIG. 4 is a flowchart illustrating a reception operation in a receiver in the STBC-using HARQ system according to an embodiment of the present invention;

FIG. 5 illustrates a signal flow for the overall operation of the STBC-using HARQ system according to an embodiment of the present invention;

FIGS. 6A and 6B respectively illustrate a quadrature phase shift keying (QPSK) mapping changing rule and a quadrature amplitude modulation (QAM) mapping changing rule according to the present invention;

FIG. 7 is a graph comparing bit error rate (BER) performance in a retransmission scheme with the QPSK mapping changing rule according to the present invention with a chase combining scheme, for an Alamouti STBC for two transmit antennas;

FIG. 8 is a graph comparing BER performance in a retransmission scheme with the QAM mapping changing rule according to the present invention with a chase combining scheme, for an Alamouti STBC for two transmit antennas; and

FIG. 9 is a graph comparing throughput for the STBC QPSK scheme of the present invention (STBC QPSK new) with a conventional chase combining (STBC QPSK Chase Combining) scheme, and comparing the STBC QAM scheme of the present invention (STBC QAM new) with another conventional chase combining (STBC QAM Chase Combining) scheme, for two transmit antennas.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a method of changing the signal mapping rule of a modulation scheme at every retransmission in order to increase the minimum squared Euclidean distance in an STBC-using HARQ system, and is applicable to multiple access schemes including frequency division multiple access (FDMA), time division multiple access (TDMA), code division multiple access (CDMA), and orthogonal frequency division multiplexing (OFDM). The term used herein, “retransmission number k” denotes the number of transmissions of the same frame. If k=0, it indicates an initial transmission and if k=1, it indicates a second transmission.

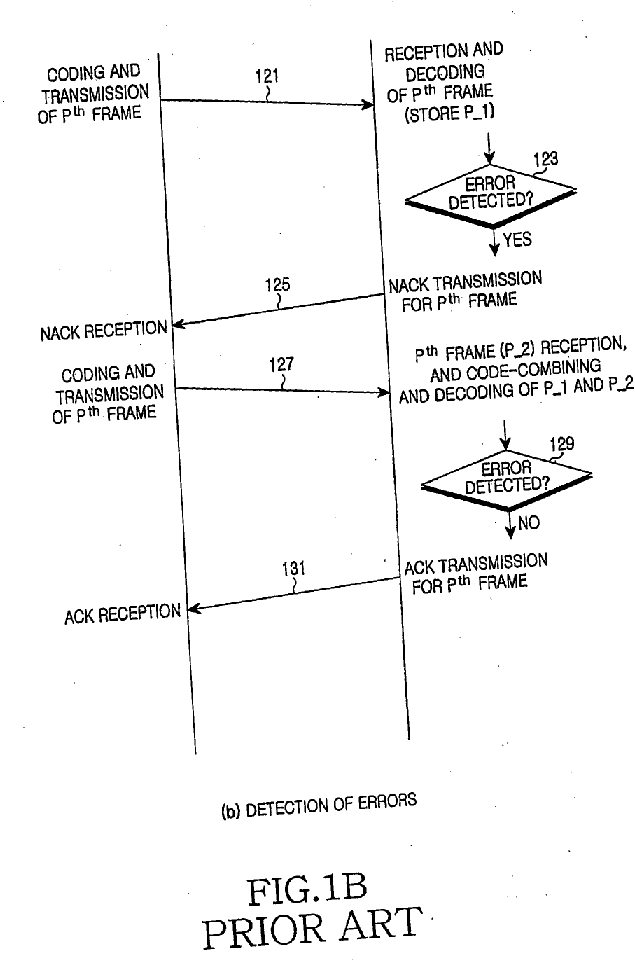

FIG. 2 is a block diagram of a MIMO-HARQ system according to an embodiment of the present invention. Referring to FIG. 2, a transmitter includes an error detection code adder 200, a modulator 201, an STC coder 202, first through n^{th} radio frequency (RF) processors 203 to 204, first through n^{th} transmit antennas 205 to 206, and a transmission controller 207. A receiver includes first through m^{th} receive antennas 211 to 212, first through m^{th} RF processors 213 to 214, an STC decoder 216, an error detector 218, and an ARQ controller 220. While the number of transmit antennas is assumed to be different from that of receive antennas, needless to say, they can be identical.

For transmission, the error detection code adder 200 attaches a predetermined error detection code to an information bit stream received on a frame basis. The error detection code is used to check errors in the frame. For example, it can be a cyclic redundancy check (CRC) code.

The modulator 201 modulates the data received from the error detection code adder 200 to complex symbols according to a signal mapping rule determined according to a retransmission number k received from the transmission controller 207. A table such as Table 1 lists signal mapping rules (i.e. constellation data). To be more specific, the modulator 201 maps the received data to signal points on the constellation determined by the retransmission number k received from the transmission controller 207. That is, the present invention sets a different signal constellation for a modulation scheme at every retransmission. The modulator 201 may operate in binary phase shift keying (BPSK), QPSK, 8QAM, or 16QAM. One bit (s=1) is mapped to one complex signal in BPSK, two bits (s=2) to one complex signal in QPSK, three bits (s=3) to one complex signal in 8QAM, and four bits (s=4) to one complex signal in 16QAM. The transmission controller 207 monitors an ACK/NACK signal received on a feedback channel from the receiver and provides a retransmission number to the modulator 201 according to the ACK/NACK signal. For example, upon receipt of the ACK signal, the transmission controller 207 sets the retransmission number k to the initial value 0. Upon receipt of the NACK signal, the transmission controller 207 increases the retransmission number k by 1.

The STC coder 202 encodes the complex symbols to a predetermined STBC, thus generating a plurality of antenna signals. The RF processors 203 to 204 modulate the baseband complex signals received from the STC coder 202 to RF signals and transmit them through their corresponding transmit antennas 205 to 206.

For reception, the first through m^{th} receive antennas 211 to 212 receive signals from the transmit antennas 205 to 206 of the transmitter. The first through m^{th} RF processors 213 to 214 each convert a signal received from a corresponding receive antenna to a (complex) baseband signal.

The STC decoder 216 obtains a received vector from the signals received from the RF processors 213 to 214, and calculates the Euclidean distances of the received vector over all possible sequences that could be transmitted according to the retransmission number k by the transmitter. It outputs an information bit stream having the minimum Euclidean distance as a received frame.

For instance, if the transmitter transmits two QPSK symbols through two transmit antennas in one time interval, they arrive at the receiver, in combination on a channel. Since there are 4 QPSK signal points, the combination of the two complex symbols is one of 16 (4×4) signal points. Here, one signal point corresponds to four information bits. Therefore, the receiver calculates the Euclidean distance between the received signal point and each of the 16 reference signal points and estimates four information bits having the minimum Euclidean distance as those transmitted by the transmitter. At a second transmission, the calculated 16 metric values (i.e. Euclidean, distances) are added to 16 metric values calculated at the previous transmission in a one-to-one correspondence, and information bits having the smallest sum are determined as those transmitted by the transmitter. While many algorithms can be used to determine information bits based on the Euclidean distance, a Viterbi algorithm is assumed herein.

The error detector 218 extracts an error detection code (e.g. a CRC) from the frame data received from the STC decoder 216 and checks errors in the frame data using the error detection code. In the absence of errors, the error detector 218 provides a success signal to the ARQ controller 220, and in the presence of errors, it provides a fail signal to the ARQ controller 220.

The ARQ controller 220 transmits an ACK or NACK signal to the transmitter according to the error check result from the error detector 218. Upon receipt of the success signal from the error detector 218, the ARQ controller 220 transmits an ACK signal to the transmitter on a feedback channel. Upon receipt of the fail signal from the error detector 218, the ARQ controller 220 transmits an NACK signal to the transmitter on the feedback channel. Meanwhile, the ARQ controller 220 provides decoding information (i.e. a retransmission number) to the STC decoder 216 to help decoding.

As described above, the receiver checks errors in the decoded frame using the error detection code. In the absence of errors in the information frame, the ARQ controller 220 requests transmission of the next frame from the transmitter by transmitting the ACK signal on the feedback channel. Otherwise, in the presence of errors in the information frame, the ARQ controller 220 requests a retransmission from the transmitter by transmitting the NACK signal on the feedback channel. The transmission controller 207 of the transmitter decides as to whether to transmit the next frame or retransmit the previous frame according to the ACK/NACK signal. In the case of retransmitting the information frame, the transmitter transmits a different frame from the transmitted frame using a different signal mapping rule according to the retransmission number. The signal mapping rule is changed based on the criterion of maximizing the minimum squared Euclidean distance.

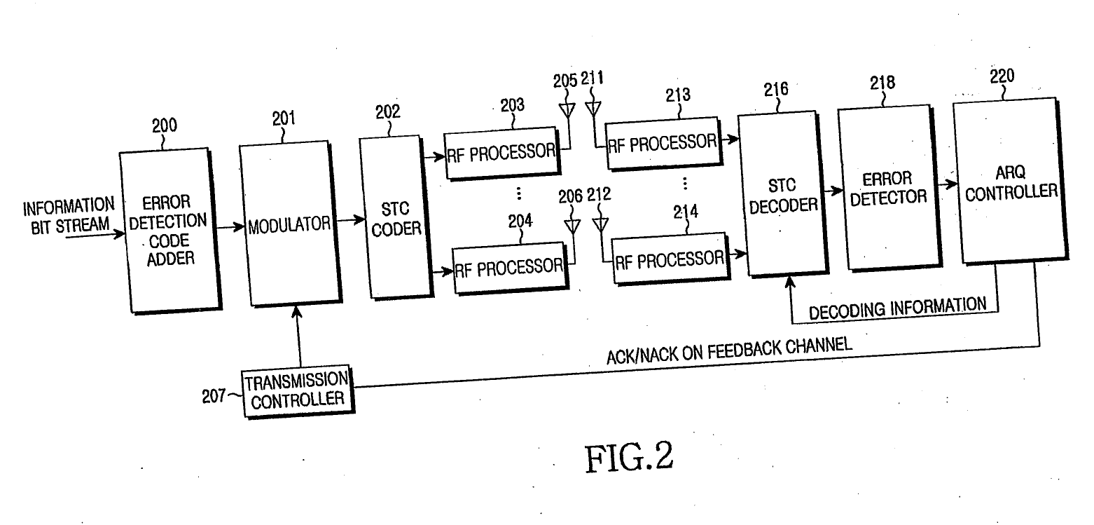

FIG. 3 is a flowchart illustrating a transmission operation in the transmitter in the STBC-using HARQ system according to an embodiment of the present invention. Referring to FIG. 3, the transmitter calculates an error detection code (e.g. CRC) for transmission data and attaches the error detection code to the transmission data, thus generating frame data in step 301.

The transmitter checks the current retransmission number in step 303 and reads a signal mapping rule (or a constellation) corresponding to the retransmission number in step 305. As described before, the signal constellation of a predetermined modulation scheme is changed at every retransmission according to the present invention. In step 307, the transmitter modulates the frame data to complex symbols according to the signal mapping rule. The transmitter encodes the complex symbols to a predetermined STBC, thus generating a plurality of antenna signals in step 309. In step 311, the transmitter converts the antenna signals to RF signals and transmits the RF signals through a plurality of transmit antennas.

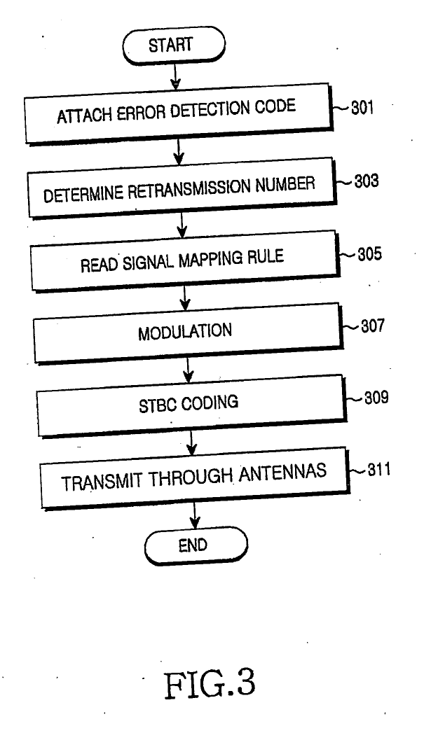

FIG. 4 is a flowchart illustrating a reception operation in the receiver in the STBC-using HARQ system according to an embodiment of the present invention. Referring to FIG. 4, the receiver converts a signal received through at least one receive antenna to a complex baseband signal (or complex symbols) in step 401 and determines whether this transmission is an initial one in step 403.

In the case of an initial transmission, the receiver reads the reference signal points of a constellation set for the initial transmission in step 423. As described earlier, if the transmitter transmits two QPSK symbols through two transmit antennas in one time interval, 16 (4×4) reference signal points exist. The 16 reference signal points are matched to 16 information bit streams 0000 to 1111, in a one-to-one correspondence. In step 425, the receiver STBC-decodes the received complex symbols using the reference signal points. At the same time, the receiver stores metric values (Euclidean distances) calculated during the decoding as a metric for the current transmission (i.e. initial transmission) in step 427. In step 413, the receiver determines received frame data using the decoded information bit stream.

The receiver extracts an error detection code (e.g. CRC) from the frame data and checks errors in the frame data using the error detection code in step 415. In step 417, the receiver determines whether the frame data has errors. In the absence of errors, the receiver initializes a buffer that keeps the previous transmission metric in step 429, and transmits an ACK signal to the transmitter in step 431. Then, the procedure ends. On the other hand, in the presence of errors, the receiver stores the current calculated metric in the buffer in step 419 and transmits an NACK signal to the transmitter, requesting a retransmission in step 421. Then the procedure ends.

Alternatively, in the case of a retransmission in step 403, the receiver reads reference signal points corresponding to the current retransmission number in step 405. In step 407, the receiver STBC-decodes the received complex symbols using the reference signal points. At the same time, the receiver stores metric values calculated during the decoding as a metric for the current transmission in step 409.

In step 411, the receiver combines the current transmission metric with the previous metric. Combining metrics is equivalent to adding corresponding metric values from the two metrics. In step 413, the receiver determines an information bit stream as received frame data based on the combined metric values.

The receiver then extracts an error detection code from the frame data and checks errors in the frame data using the error detection code in step 415. In step 417, the receiver determines whether the frame data has errors. In the absence of errors, the receiver initializes the buffer that keeps the previous transmission metric in step 429, and transmits an ACK signal to the transmitter in step 431. Then, the procedure ends. On the other hand, in the presence of errors, the receiver stores the current calculated metric in the buffer in step 419 and transmits an NACK signal to the transmitter, requesting a retransmission in step 421. Then the procedure ends.

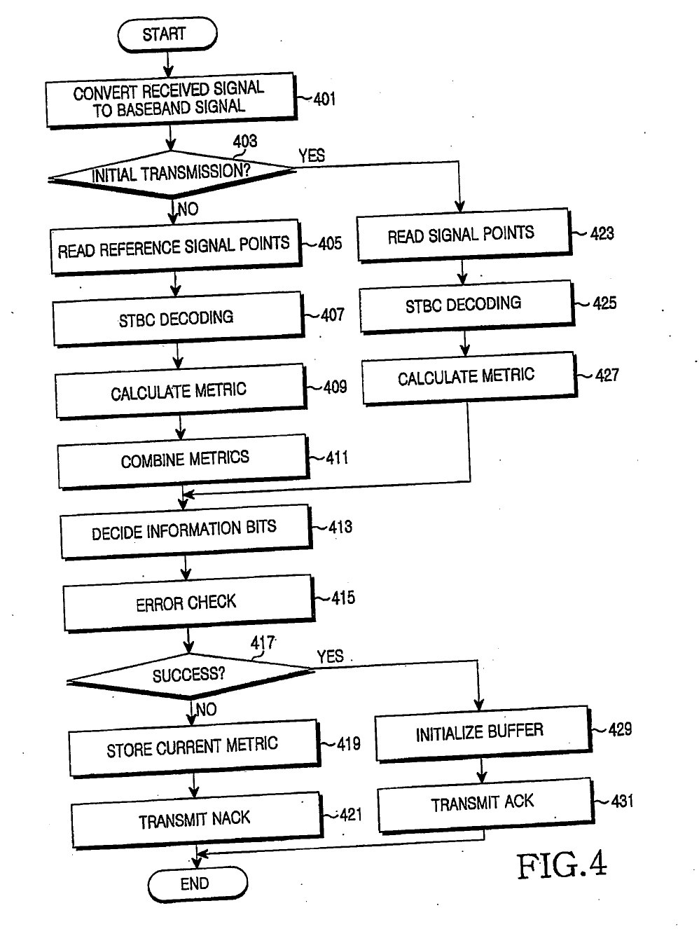

FIG. 5 illustrates a signal flow for the overall operation of the STBC-using HARQ system according to an embodiment of the present invention. Referring to FIG. 5, the transmitter STBC-encodes a P^{th} frame according to a signal mapping rule M1 and transmits the Ph frame in step 501. The receiver calculates a metric P_1 representing the distances between the P^{th} frame and reference signal points obtained according to the signal mapping rule M1 and decodes the P^{th} frame using the metric P_1, thereby recovering an information bit stream transmitted by the transmitter in step 503. In step 505, the receiver extracts an error detection code (e.g. CRC) from the decoded information bit stream and checks errors in the frame data using the error detection code. In the presence of errors in the P^{th} frame, the receiver stores the metric P_1 in a predetermined buffer and transmits an NACK signal to the transmitter, requesting a retransmission in step 507.

In step 509, the transmitter receives the NACK signal. The transmitter STBC-encodes the P^{th} frame using a signal mapping rule M2 and retransmits the P^{th} frame in step 511. The receiver calculates a metric P_2 representing the distances between the retransmitted P^{th} frame and reference signal points acquired according to the signal mapping rule M2 and decodes an information bit stream by combining the metrics P_1 and P_2 in step 513. In step 515, the receiver extracts an error detection code from the decoded information bit stream and checks errors in the frame data using the error detection code. In the presence of errors in the Ph frame, the receiver stores the metric P_2 in a predetermined buffer and transmits an NACK signal to the transmitter in step 517.

In step 519, the transmitter receives the NACK signal again. The transmitter STBC-encodes the P^{th} frame using a signal mapping rule M3 and retransmits the P^{th} frame in step 521. The receiver calculates a metric P_3 representing the distances between the retransmitted P^{th} frame and reference signal points acquired according to the signal mapping rule M3 and decodes an information bit stream by combining the metric P_3 with the metrics P_1 and P_2 in step 523. In step 525, the receiver extracts an error detection code from the decoded information bit stream and checks errors in the frame data using the error detection code. In the absence of errors in the P^{th} frame, the receiver transmits an ACK signal to the transmitter in step 527.

The transmitter receives the ACK signal in step 529. It then STBC-encodes a (P+1)^{th} frame according to the signal mapping rule M1 and transmits the (P+1)^{th} frame in step 531.

In the above embodiment of the present invention, the mapping rules M1, M2 and M3 are optimized according to the performance criterion of maximizing the minimum squared Euclidean distance. For instance, optimized mapping rules for an HARQ system using QPSK are illustrated in Table 1. Table 1 below lists true I and Q values for input bits according to the retransmission number.

TABLE 1

| | Initial transmission | | |
|---|---|---|---|
| | (I, Q) | Second transmission | Third transmission |
| 00 | (0.7070, 0.7070) | (0.7070, 0.7070) | (0.7070, 0.7070) |
| 01 | (−0.7070, 0.7070) | (−0.7070, 0.7070) | (−0.7070, 0.7070) |
| 10 | (0.7070, −0.7070) | (−0.7070, 0.7070) | (−0.7070, 0.7070) |
| 11 | (−0.7070, −0.7070) | (0.7070, −0.7070) | (0.7070, −0.7070) |

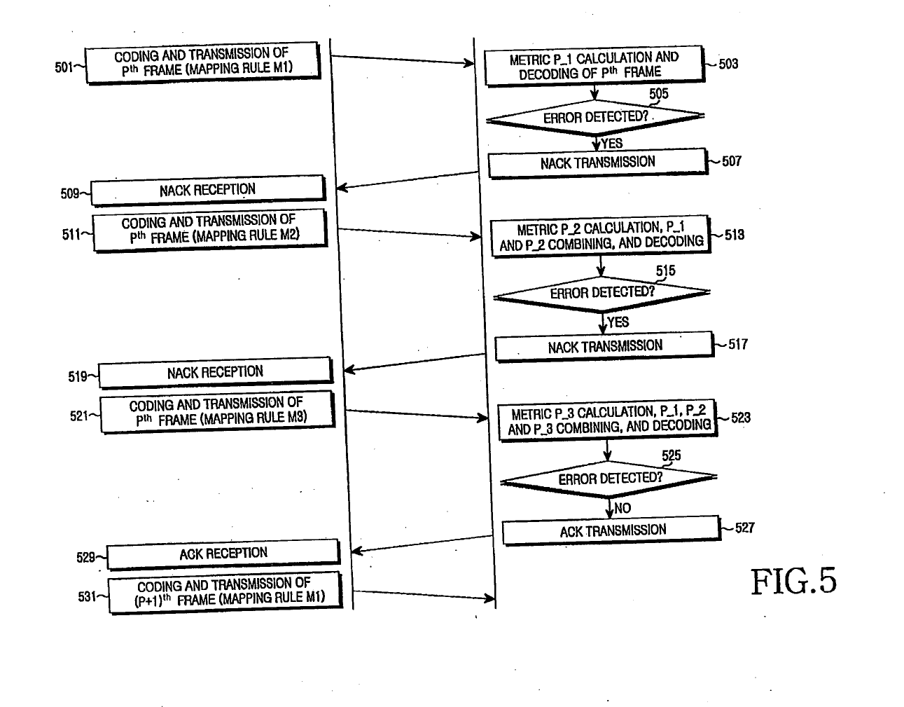

The rule of changing the constellation shown in Table 1 is depicted in FIGS. 6A and 6B. FIG. 6A illustrates a constellation changing rule for QPSK and FIG. 6B illustrates a constellation changing rule for 16QAM.

Regarding 4-ary modulation {for example QPSK, QFSK (Quadrature Frequency Shift Keying), QASK (Quadrature Amplitude Shift Keying)}, a constellation with Gray mapping is given for an initial transmission:

(1) A specific signal point is set as a base on the initial transmission constellation.

(2) The relative Euclidean distances between the base and the other signal points are calculated, and signal points having the same Euclidean distance are grouped.

(3) A nearby signal point is exchanged with a remote signal point with respect to the base on the initial transmission constellation. In other words, the information bits of the signal points are exchanged.

(4) Step (3) is repeated until no signal points to be exchanged remain.

The above procedure will be described in the context of QPSK with reference to FIG. 6A:

(1) A signal point ‘00’ is selected as a base on an initial transmission constellation for QPSK.

(2) Signal points ‘01’ and ‘10’ have a Euclidean distance of 2 with respect to the base, and a signal point ‘11’ has a Euclidean distance of 4 with respect to the base. Thus the signal points ‘01’ and ‘10’ are grouped into one group, and the signal point ‘11’ is classified as another group.

(3) One of the signal points with Euclidean distance 2, ‘10’ is exchanged with the signal point ‘11’. Since the other signal point with Euclidean distance 2, ‘01’ has no counterpart to be exchanged with, it keeps its position. Thus, a constellation for the second transmission is constructed.

(4) The signal point ‘01’ is exchanged with the signal point ‘11’ on the initial transmission constellation, thereby constructing a constellation for the third transmission. Exchanging ‘01’ with ‘11’ means that ‘01’ is moved to a position with Euclidean distance 4 with respect to the base, and ‘11’ is moved to a position with Euclidean distance 2 with respect to the base. Since no signal points to be exchanged remain, the procedure of constructing the constellation is terminated.

As described above, for QPSK, three constellations are constructed by allocating information bits ‘01’ and ‘10’ with Euclidean distance 2 each to a signal point with Euclidean distance 4 with respect to the base ‘00’. These constellations shown in FIG. 6A are a mere exemplary application and clearly, three constellations satisfying the constellation changing rule may be created in various ways. The constellation changing rule illustrated in FIG. 6A is also applicable to 4-ary modulation and QAM.

Referring to FIG. 6B illustrating constellations for 16QAM, the upper two bits of four bits mapped to one signal point represent an I axis value and the lower two bits thereof represent a Q axis value. Upper two bits, 00, 01, 11 and 10 are allocated in every row (or along the I axis) by Gray mapping, and lower two bits, 00, 01, 11 and 10 are allocated in every column (or along the Q axis) by Gray mapping. That is, 16QAM with Gray mapping uses I-axis 4-ary mapping and Q-axis 4-ary mapping. Therefore, constellations for second and third transmissions are constructed by applying the above-described constellation changing rule to the I and Q axes, independently.

To be more specific, a column with an I-axis value of ‘11’ is exchanged with a column with an I-axis value of ‘10’ and then a row with a Q-axis value of ‘11’ is exchanged with a row with a Q-axis value of ‘10’ on a constellation for an initial transmission, thereby producing a constellation for a second transmission. To construct a constellation for a third transmission, a column with an I-axis value of ‘01’ is exchanged with a column with an I-axis value of ‘10’ and then a row with a Q-axis value of ‘01’ is exchanged with a row with a Q-axis value of ‘10’ on the constellation for the second transmission. If the retransmission number is larger than 2, the mapping rules (or constellations) for the first, second and third transmissions are repeated periodically. The same QAM constellation changing rule can be applied to a typical hexadecimal number signal other than a signal set branched into the I and Q axes.

A comparison between the retransmission scheme of the present invention and a conventional retransmission scheme in terms of performance will be given below. The performance can be evaluated by calculating the minimum Euclidean distance over all possible cases of information bits having errors, and the number of cases with the minimum Euclidean distance. Table 2 below lists minimum Euclidean distances and associated numbers of error occurrences (the number of cases having the minimum Euclidean distance).

TABLE 2

| | | Minimum squared Euclidean distance | |
|---|---|---|---|
| | | (error frequency) | |
| | | Present invention | Chase combining |
| QPSK | Second transmission | 4.00(2) | 4.00(4) |
| | Third transmission | 8.00(6) | 6.00(4) |
| QAM | Second transmission | 0.80(16) | 0.80(24) |
| | Third transmission | 2.40(32) | 1.20(24) |

As noted from Table 2, although the present invention and the chase combining have an equal minimum squared Euclidean distance at the second transmission, the number of error occurrences is less in the former than in the latter. Therefore, the present invention is expected to provide better performance. At the third transmission, despite an increase in the number of error occurrences, the minimum squared Euclidean distance increases from 6 to 8 in QPSK and from 1.2 to 2.4 in QAM according to the present invention. Considering that the minimum squared Euclidean distance is typically a more dominant factor of performance than the number of error occurrences, the present invention outperforms the conventional chase combining. Accordingly, it is preferred that a constellation for a k^{th} retransmission (k=0, 1, 2, . . . ) is designed to maximize the minimum of the Euclidean distances computed by combining the Euclidean distances between the signal points of constellations for first to (k−1)^{th} retransmissions with the Euclidean distances between the signal points of the constellation for the k^{th} retransmission.

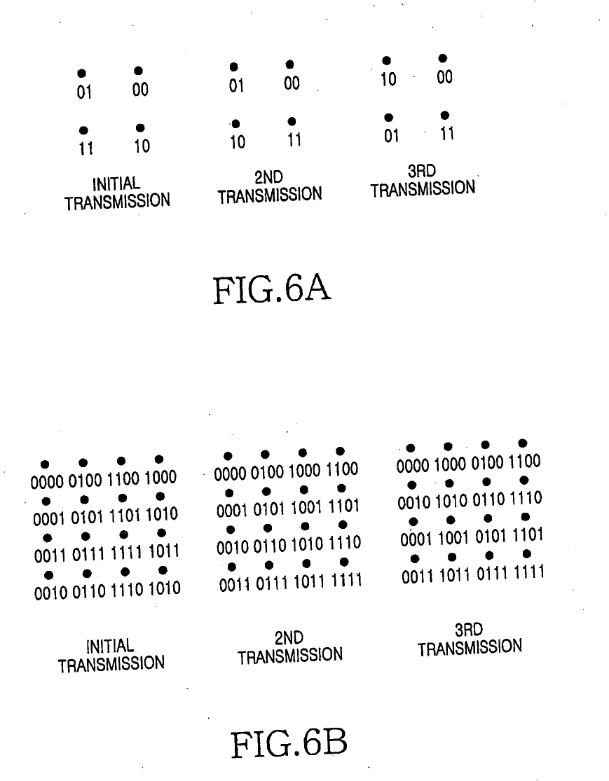

FIG. 7 is a graph comparing bit error rate (BER) performance for a retransmission scheme with the QPSK mapping changing rule according to the present invention with a chase combining scheme, for an Alamouti STBC for two transmit antennas. This graph was drawn under the assumption of a quasi-static fading channel environment. The horizontal axis represents energy-to-noise ratio per bit (Eb/No) and the vertical axis represents the BER of a combined code. As noted from the graph, the present invention (Tx new) provides an about 0.1-dB performance gain at a second transmission and an about 0.3-dB performance gain at a BER of 10⁻⁵, compared to chase combining of the Alamouti STBC (Tx).

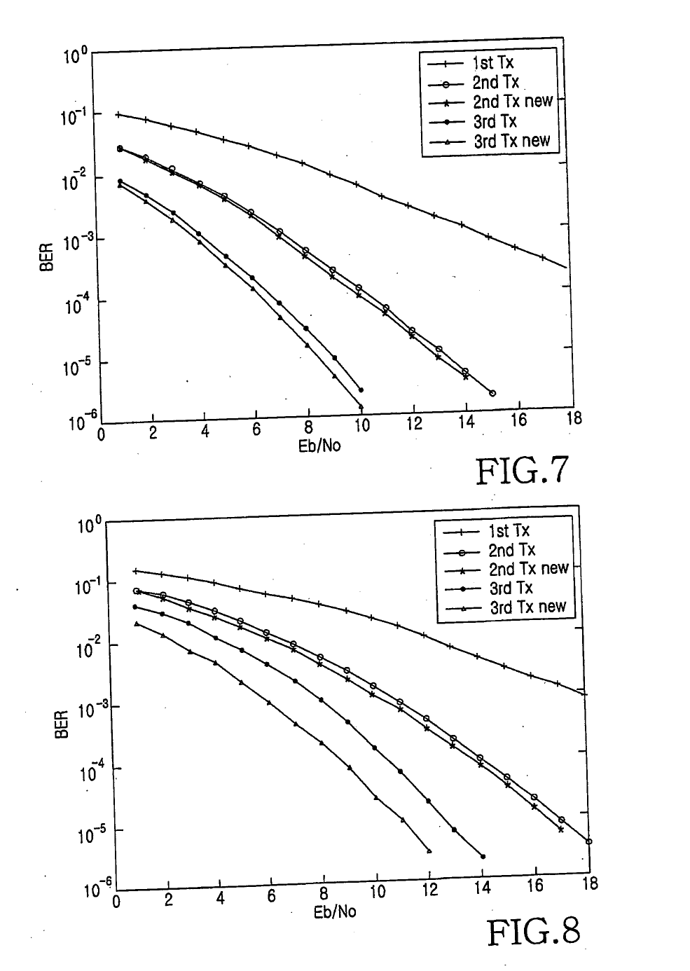

FIG. 8 is a graph comparing bit error rate (BER) performance for a retransmission scheme with the QAM mapping changing rule according to the present invention with a chase combining scheme, for an Alamouti STBC for two transmit antennas. This graph was drawn under the assumption of a quasi-static fading channel environment. The horizontal axis represents energy-to-noise ratio per bit (Eb/No) and the vertical axis represents the BER of a combined code. As noted from the graph, the present invention (Tx new) provides an about 0.1-dB performance gain at a second transmission and an about 0.5-dB performance gain at a BER of 10⁻⁵, compared to chase combining of the Alamouti STBC (Tx).

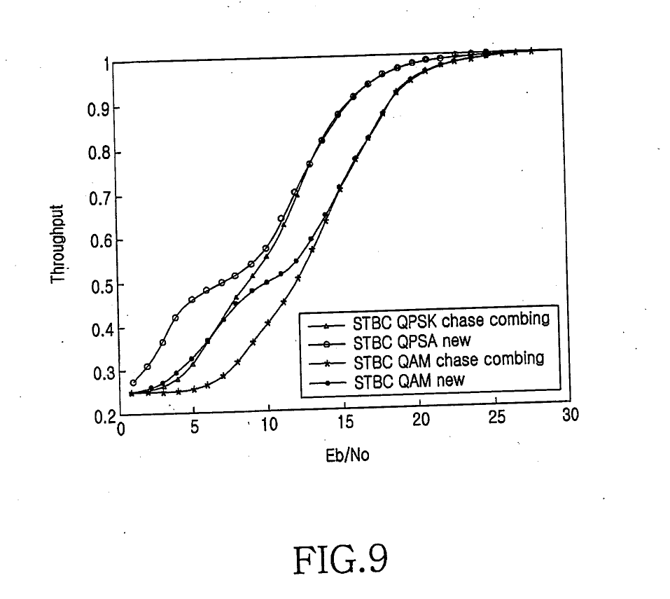

In general, the ARQ system defines performance in terms of throughput. Throughput is a measure of how much unit information can be sent at a given SNR to a receiver. FIG. 9 is a graph comparing throughput for the STBC QPSK scheme of the present invention (STBC QPSK new) with a conventional chase combining (STBC QPSK Chase Combining), and comparing the STBC QAM scheme of the present invention (STBC QAM new) with another conventional chase combining (STBC QAM Chase Combining), for two transmit antennas. Here, a QPSK block size is 260 bits and a QAM block size is 240 bits. As noted from FIG. 9, compared to the conventional retransmission scheme of transmitting the same initial transmission code and decoding it by chase combining, the present invention provides a throughput gain all the time in a low SNR range.

As described above, the present invention improves decoding performance in decoding based on code combining because a signal mapping rule is changed for a retransmission frame in terms of the minimum squared Euclidean distance in an HARQ system. The mapping changing rule of the present invention has excellent performances especially in a MIMO environment.

Under the same condition, optimization of an STC code by changing a signal constellation for modulation achieves a greater link-level performance, thereby increasing system throughput.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A transmitter in an automatic repeat request (ARQ) system, comprising:
a memory for storing different signal constellations for a predetermined modulation scheme according to retransmission numbers (k); and
a modulator for reading a signal constellation according to a current retransmission number from the memory, upon receipt of a retransmission request signal from a receiver, and modulating transmission data to complex symbols on the signal constellation.

2. The transmitter of claim 1, further comprising a space-time coder for space-time coding the complex symbols received from the modulator, for transmission through a plurality of transmit antennas.

3. The transmitter of claim 1, further comprising an error detection code adder for adding an error detection code to an information bit stream received on a frame basis and providing the information bit stream with the error detection code as the transmission data to the modulator.

4. The transmitter of claim 3, wherein the error detection code is a cyclic redundancy check (CRC) code.

5. The transmitter of claim 1, wherein a signal constellation for a k^{th} retransmission maximizes the minimum of Euclidean distances computed by combining the Euclidean distances between signal points of constellations for first to (k−1)^{th} retransmissions with the Euclidean distances between the signal points of the constellation for the k^{th} retransmission.

6. The transmitter of claim 1, wherein if the modulation scheme is quadrature phase shift keying (QPSK), a signal constellation for an initial transmission (k=0) is constructed by Gray mapping, a signal constellation for a second transmission is constructed by exchanging one of two nearby signal points with a remote signal point with respect to a predetermined signal point set as a base on the initial transmission constellation, and a signal constellation for a third transmission is constructed by exchanging the other nearby signal point with the remote signal point with respect to the base on the initial transmission constellation.

7. The transmitter of claim 1, wherein if the modulation scheme is quadrature amplitude modulation (QAM), a constellation corresponding to a retransmission number is constructed by applying a signal point exchanging rule set for quadrature phase shift keying (QPSK) to I and Q axes, independently.

8. The transmitter of claim 1, wherein a constellation for a second or higher-numbered transmission is constructed by exchanging a signal point with a small Euclidean distance with respect to a base with a signal point with a large Euclidean distance with respect to the base on a signal constellation for an initial transmission.

9. A receiver in an automatic repeat request (ARQ) system having a table for storing different signal constellations for a predetermined modulation scheme according to a retransmission number (k), comprising:
a decoder for acquiring a metric for a current transmission by decoding received complex symbols using reference signal points from a signal constellation corresponding to a current retransmission number, combining the metric for the current transmission with metrics for previous transmissions, and deciding received data based on the combined metric;
an error detector for checking errors in the received data from the decoder; and
an ARQ controller for transmitting a feedback signal to a transmitter according to an error check result received from an error detector.

10. The receiver of claim 9, wherein if the modulation scheme is quadrature phase shift keying (QPSK), a signal constellation for an initial transmission (k=0) is constructed by Gray mapping, a signal constellation for a second transmission is constructed by exchanging one of two nearby signal points with a remote signal point with respect to a predetermined signal point set as a base on the initial transmission constellation, and a signal constellation for a third transmission is constructed by exchanging the other nearby signal point with the remote signal point with respect to the base on the initial transmission constellation.

11. The receiver of claim 9, wherein if the modulation scheme is quadrature amplitude modulation (QAM), a constellation corresponding to a retransmission number is constructed by applying a signal point exchanging rule set for quadrature phase shift keying (QPSK) to I and Q axes, independently.

12. The receiver of claim 9, wherein a signal constellation for a k^{th} retransmission maximizes the minimum of Euclidean distances computed by combining the Euclidean distances between the signal points of constellations for first to (k−1)^{th} retransmissions with the Euclidean distances between the signal points of the constellation for the k retransmission.

13. The receiver of claim 9, wherein the error detector checks errors using a cyclic redundancy check (CRC) code.

14. A transmission method in a transmitter in an automatic repeat request (ARQ) system having a table for storing different signal constellations for a predetermined modulation scheme according to a retransmission number (k), comprising the steps of:
reading a signal constellation according to a current retransmission number from the table, upon receipt of a retransmission request signal from a receiver; and
modulating transmission data to complex symbols on the signal constellation.

15. The transmission method of claim 14, further comprising space-time coding the complex symbols.

16. The transmission method of claim 14, wherein the transmission data includes an error detection code.

17. The transmission method of claim 16, wherein the error detection code is a cyclic redundancy check (CRC) code.

18. The transmission method of claim 14, wherein a signal constellation for a k^{th} retransmission maximizes the minimum of Euclidean distances computed by combining the Euclidean distances between the signal points of constellations for first to (k−1)^{th} retransmissions with the Euclidean distances between the signal points of the constellation for the k^{th} retransmission.

19. The transmission method of claim 14, wherein if the modulation scheme is quadrature phase shift keying (QPSK), a signal constellation for an initial transmission (k=0) is constructed by Gray mapping, a signal constellation for a second transmission is constructed by exchanging one of two nearby signal points with a remote signal point with respect to a predetermined signal point set as a base on the initial transmission constellation, and a signal constellation for a third transmission is constructed by exchanging the other nearby signal point with the remote signal point with respect to the base on the initial transmission constellation.

20. The transmission method of claim 14, wherein if the modulation scheme is quadrature amplitude modulation (QAM), a constellation corresponding to a retransmission number is constructed by applying a signal point exchanging rule set for quadrature phase shift keying (QPSK) to I and Q axes, independently.

21. The transmission method of claim 14, wherein a constellation for a second or higher-numbered transmission is constructed by exchanging a signal point with a small Euclidean distance with respect to a base with a signal point with a large Euclidean distance with respect to the base on a signal constellation for an initial transmission.

22. A reception method in a receiver in an automatic repeat request (ARQ) system having a table for storing different signal constellations for a predetermined modulation scheme according to a retransmission number (k), comprising the steps of:
acquiring reference signal points from a signal constellation corresponding to a current retransmission number;
acquiring a metric for a current transmission by decoding received complex symbols using the reference signal points;
combining the metric for the current transmission with metrics for previous transmissions;
deciding received data based on the combined metric;
checking errors in the received data; and
transmitting a feedback signal to a transmitter according to an error check result.

23. The reception method of claim 22, wherein if the modulation scheme is quadrature phase shift keying (QPSK), a signal constellation for an initial transmission (k=0) is constructed by Gray mapping, a signal constellation for a second transmission is constructed by exchanging one of two nearby signal points with a remote signal point with respect to a predetermined signal point set as a base on the initial transmission constellation, and a signal constellation for a third transmission is constructed by exchanging the other nearby signal point with the remote signal point with respect to the base on the initial transmission constellation.

24. The reception method of claim 22, wherein if the modulation scheme is quadrature amplitude modulation (QAM), a constellation corresponding to a retransmission number is constructed by applying a signal point exchanging rule set for quadrature phase shift keying (QPSK) to I and Q axes, independently.

25. A method of designing a quadrature phase shift keying (QPSK) constellation in an automatic repeat request (ARQ) system where transmission data is modulated on a different constellation according to a retransmission number, prior to transmission, the method comprising the steps of:
constructing an initial transmission constellation by Gray mapping;
constructing a second transmission constellation by exchanging one of two nearby signal points with a remote signal point with respect to a predetermined signal point set as a base on the initial transmission constellation; and
constructing a third transmission constellation by exchanging the other nearby signal point with the remote signal point with respect to the base on the initial transmission constellation.

26. A method of designing a quadrature amplitude modulation (QAM) constellation in an automatic repeat request (ARQ) system where transmission data is modulated on a different constellation according to a retransmission number, prior to transmission, the method comprising the steps of:
constructing an initial transmission by applying a signal point exchanging rule set for quadrature phase shift keying (QPSK) to I and Q axes, independently;
constructing a second transmission constellation by exchanging a column with an I-axis value of ‘11’ with a column with an I-axis value of ‘10’ and then exchanging a row with a Q-axis value of ‘11’ is exchanged with a row with a Q-axis value of ‘10’ on the initial transmission constellation; and
constructing a third transmission constellation by exchanging a column with an I-axis value of ‘01’ is exchanged with a column with an I-axis value of ‘10’ and then exchanging a row with a Q-axis value of ‘01’ with a row with a Q-axis value of ‘10’ on the second transmission constellation.
